(19) United States
(12) Patent Application Publication
(10) Pub. No.: US 2004/0231809 A1
(43) Pub. Date: Nov. 25, 2004

(54) Frictional gripping window cover

(75) Inventor: Alan J. Wheatley, Draper, UT (US)

Correspondence Address: Garron M. Hobson, THORPE NORTH & WESTERN, LLP, P.O. Box 1219, Sandy, UT, 84091-1219, US

(73) Assignee: American Covers, Inc.

(21) Appl. No.: 10/791,304

(22) Filed: Mar. 1, 2004

Related U.S. Application Data
(60) Provisional application No. 60/451,173, filed on Feb. 28, 2003.

(51) Int. Cl. B60J 1/20

(52) U.S. Cl. 160/370.21

(57) ABSTRACT

A window cover for restricting sunlight through a window has an attachment surface that clings to the window in a frictional grip with mechanical or specific adhesion. The window cover can include a sheet of polyvinyl chloride material with a coating of polyurethane.

This application claims the benefit of U.S. Provisional Patent Application No. 60/451,173, filed Feb. 28, 2003.

### BACKGROUND OF THE INVENTION

1. Field of the Invention

The present invention relates generally to window covers or shades. More particularly, the present invention relates to window covers or shades configured to grip a window surface in a frictional manner, or with mechanical or specific adhesion.

2. Related Art

Window shades are commonly used to block or screen sunlight from a desired area, or through a desired window. Common applications include automobile windows in which such a block or screen is disposed across the window to prevent or restrict the sunlight from passing through the window and onto items, such as infants or children. Such blocks or screens can be translucent or only partially opaque so that sunlight is restricted, while still allowing visibility through the window. It will be appreciated that in automobile application it can be necessary to maintain visibility.

One example of such a shade includes a material extending across the window and held in place by suction cups secured directly to the window surface, and/or by clips extending around the window edges, such as at the top of the window. It will be appreciated that attaching fasteners, such as the suction cups or clips, directly to the window can hinder or prevent operation of the window. For example, the suction cups or hooks can catch in the doorframe if the window is retracted into the door. In addition, such shades can also include a retracting mechanism in which the sheet is rolled. Such retracting mechanisms can be difficult to operate, unsightly, and can still interfere with window operation.

Another example of such a shade includes a sheet of plastic material that sticks to the window surface. Such sheets tend to be difficult to apply to the windows, and can result in aesthetically unpleasant bubbles and/or folds in the sheet. Again, such bubbles or folds, or even the thickness of the sheet, can interfere with the operation of the window as it retracts into the door. Some materials or window tints permanently adhere to the window, requiring professional installation and/or removal.

### SUMMARY OF THE INVENTION

It has been recognized that it would be advantageous to develop a window cover, shade, screen, or the like capable of restricting sunlight through a window, without interfering with operation of the window. In addition, it has been recognized that it would be advantageous to develop such a window cover capable of being easily installed. Furthermore, it has been recognized that it would be advantageous to develop such a window cover that is aesthetically acceptable.

The invention provides a window cover that has an attachment surface capable of clinging to a window surface in a frictional manner, or with mechanical or specific adhesion, without mechanical fasteners or chemical adhesives. The cover can include a sheet that is opaque with an array of transparent or translucent portions to provide for visibility through the sheet, while restricting a substantial portion of light from traveling through the sheet. The array can include an array of apertures formed through the sheet. The sheet can be relatively thin, so as not to interfere with the doorframe when the window is retracting, and can cling to the window such that the cover remains on the window, even when the window is retracted.

In accordance with a more detailed aspect of the present invention, the sheet can include a polyvinyl chloride material. In accordance with another more detailed aspect of the present invention, the sheet can have a coating of polyurethane on the attachment surface.

In accordance with another more detailed aspect of the present invention, the cover or sheet can be provided in a rolled-up, tubular or cylindrical configuration. In addition, the cover or sheet can be provided, packaged, and/or marketed in a tube. Furthermore, the sheet can be provided with a backing layer to which the sheet clings prior to installation.

A method of using the window cover described above includes removing the cover from the packaging, such as the tube. The cover can be unrolled if necessary. The backing layer is then removed, such as by peeling the backing layer from the sheet. The cover can then be positioned against the window in a desired location, with the cover clinging to the window surface in a frictional manner. An edge of the cover can be placed against the window, and then an adjacent portion of the cover can be placed against the window. The window can then be retracted and extended as desired.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a front view of a window cover in accordance with an embodiment of the present invention shown installed on an automobile window;

FIG. 2 is a front view of the window cover of FIG. 1 shown installed on an automobile window in a partially retracted position;

FIG. 3 is a front view of the window cover of FIG. 1;

FIG. 4 is a front view of another window cover in accordance with the present invention;

FIG. 5 is an exploded perspective view of the window cover of FIG. 1 shown with packaging in accordance with the present invention;

FIG. 6 is a perspective view of the window cover of FIG. 1 shown in a partially unrolled configuration; and

FIG. 7 is a perspective view of the window cover of FIG. 1 shown with a backing layer being removed.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

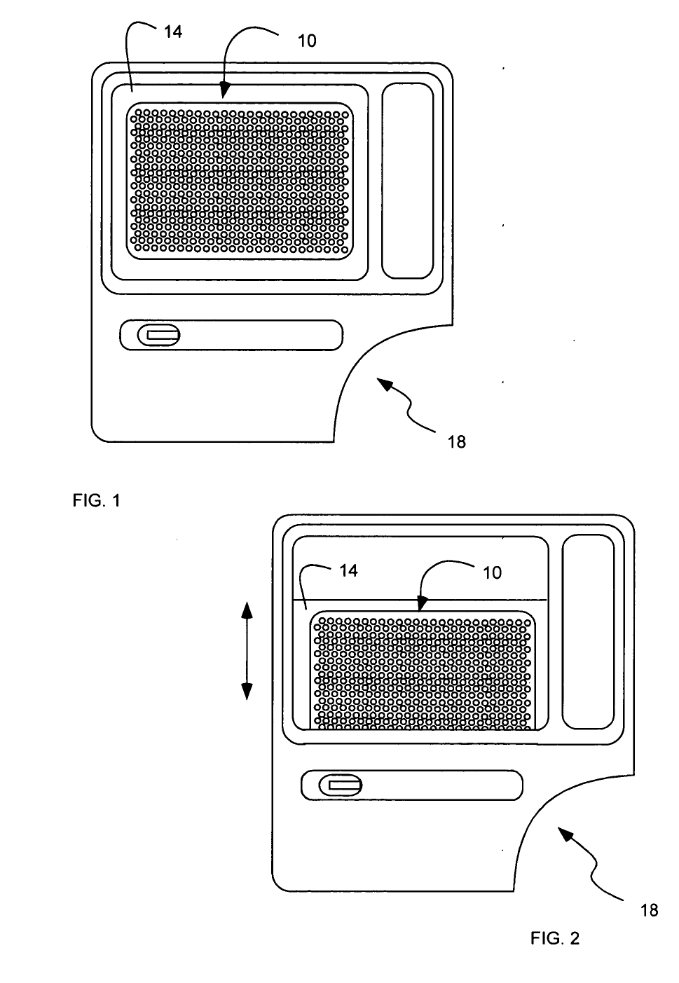

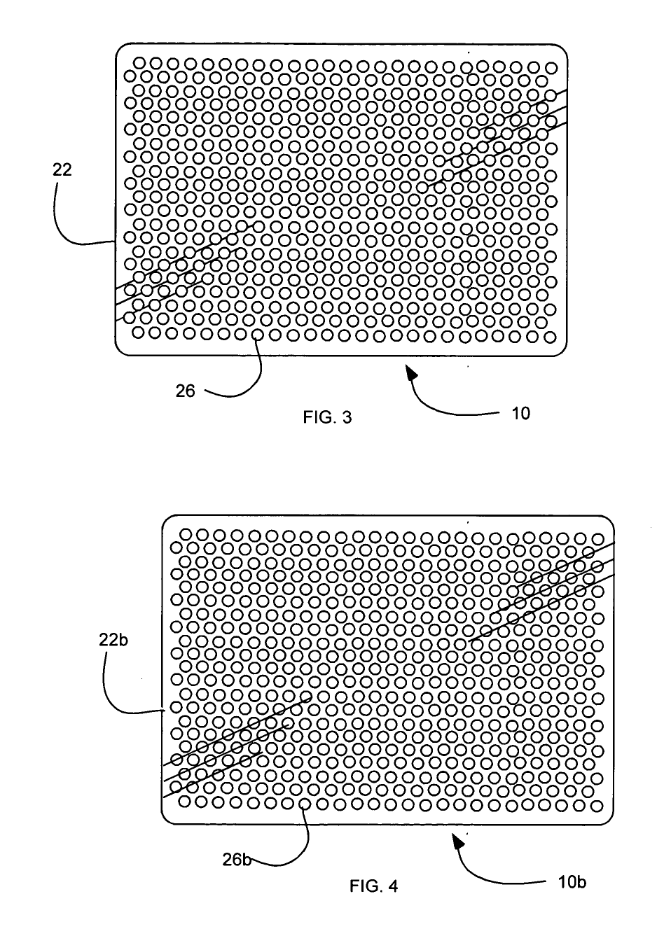

As illustrated in the FIGS. 1-3, a window cover, indicated generally at 10, in accordance with the present invention is shown that restricts sunlight and advantageously grips a window or window surface 14 in a frictional manner, or with mechanical or specific adhesion. Vehicle windows and infant/child protection are examples of fields that can benefit from the present invention. While the window cover 10 is shown and described herein as clinging to a vehicle window 14 of a vehicle doorframe 18, it will be appreciated that the window cover 10 can be used on any type of window, including for example, building or house windows, etc.

The window cover 10 can be, or can include, a sheet 22 having a substantially planar configuration for being disposed on substantially planar windows. In addition, the sheet 22 can be flexible, or formed of a flexible material, to conform to contours or curves of a curved or contoured window. The sheet 22 can be relatively thin, such as less than 0.006 inches thick, so that the sheet 22 can pass through the doorframe 18 with the window without interfering with the doorframe, as shown in FIG. 2. The sheet can be substantially opaque, and can be colored (such as black), to resist light from passing therethrough. (It is of course understood that the cover 10b or sheet can be translucent or can have a lighter color.) The sheet can be entirely opaque, or can have portions that are opaque. Thus, the sheet can be patterned as desired to control light, or to provide shade as desired.

An array or matrix of apertures 26 can be formed in the sheet 22 to allow visibility through the otherwise opaque or translucent sheet. The apertures can have a diameter of approximately 1/16 of an inch, and can be spaced-apart approximately 1/16 of an inch. The sheet can have apertures spaced with a density of approximately 96 apertures per square inch. The apertures can have a uniform diameter. In addition, the apertures can have a spacing between adjacent apertures that is substantially equal to a diameter of the apertures. It has been found that such a configuration of apertures provides a desired amount of shade, or degree of shade.

Alternatively, as shown in FIG. 4, a cover 10b includes an opaque sheet 22b with a matrix of translucent portions 26b, that may be similar to the apertures described above.

Referring again to FIGS. 1-3, the cover 10 or sheet can be sized and shaped to substantially cover the desired window or area. For example, the cover or sheet can have a substantially rectangular shape, and can have a width of approximately 14 inches and a height of approximately 12 inches. It is of course understood that the cover can have any desired shape or size. In addition, the sheet can have corners that are rounded to prevent small areas or sharp corners that can peel away from the window. The corners can have a radius of curvature of approximately ¾ of an inch. It has been found that such a radius provides the corners with sufficient ability to remain against the window surface without peeling therefrom.

The cover 10 or sheet 22 can have an attachment surface that clings to the window surface 14 in a frictional manner, without mechanical fasteners or chemical adhesives. As such, adhesion between the attachment surface and the window is primarily by mechanical and/or specific adhesion. Thus, the cover 10 or sheet 22 can cling to the window without marring the window or leaving a residue. The frictional cling of the cover or sheet allows the cover or sheet to be removed and reapplied as desired.

The cover 10 or sheet 22 can be formed of a tacky material. For example, the material might be polyvinyl chloride (PVC), partially cured PVC, expanded vinyl or polyurethane. In addition, the sheet of material can include a thin layer of polyurethane, or a thin polyurethane coating. For example, the sheet of material can be a polyvinyl chloride with a coating of polyurethane. The attachment surface can be formed on the side of the cover having the coating of polyurethane. It has been found that such materials provide a good frictional or “tacky” quality that remains disposed on the surface. In addition, it has been found that such materials typically can be disposed on the surface without marring or otherwise chemically interfering with the window or other materials, such as vehicle dashboards. It will be appreciated that marring or residue on the window presents an aesthetically displeasing appearance. In addition, it will be appreciated that widows can be subjected to extreme condition, such as heat and sunlight or freezing temperatures. It has been found that such materials not only provide the required fixed relationship with the surface, but also typically do so without chemically interacting with the material or surface, or otherwise damaging the surface.

The material can form a temporary or releasable non-chemical bond with the surface. The cover 10 can be removed from the surface 14 without leaving behind any residue and without damaging the cover. In this manner, the cover 10 can be easily moved to any location the user desires. Because the cover is made from such materials, it can be easily cleaned with soap and water, while still retaining its tackiness. The cover can thus be reusable. In addition, the material can be translucent.

The cover 10 also can include indicia formed on one or both of the surfaces. The indicia can be formed by ink, or ink-like materials, printed on or applied to the surface. The indicia can include: art work, a logo, an advertisement, an instruction, a promotion, a company name, and a product name. Thus, the cover 10 can be used as a promotional item by including a business or product logo or name. It will be appreciated that such covers can be inexpensively manufactured, and in use, can occupy a position of high and frequent visibility. Thus, such covers can be inexpensively manufactured, and given away as promotional items. In addition, the indicia can include instructions that can be related or unrelated to the use or care of the cover. For example, the instructions can include how to use or place the cover on the window, and how to clean or wash the cover. As another example, the indicia can include a warning, such as regarding sunlight.

The cover or material can be translucent or transparent, and can include printing on either surface so that it can be visible on either side. For example, the indicia can be formed on the attachment surface, and thus located between the sheet and the window. Such a configuration can protect the indicia from being scratched. As another example, the indicia can be formed on the surface opposite the attachment surface. Such a configuration can allow the indicia to be viewed if the sheet is opaque.

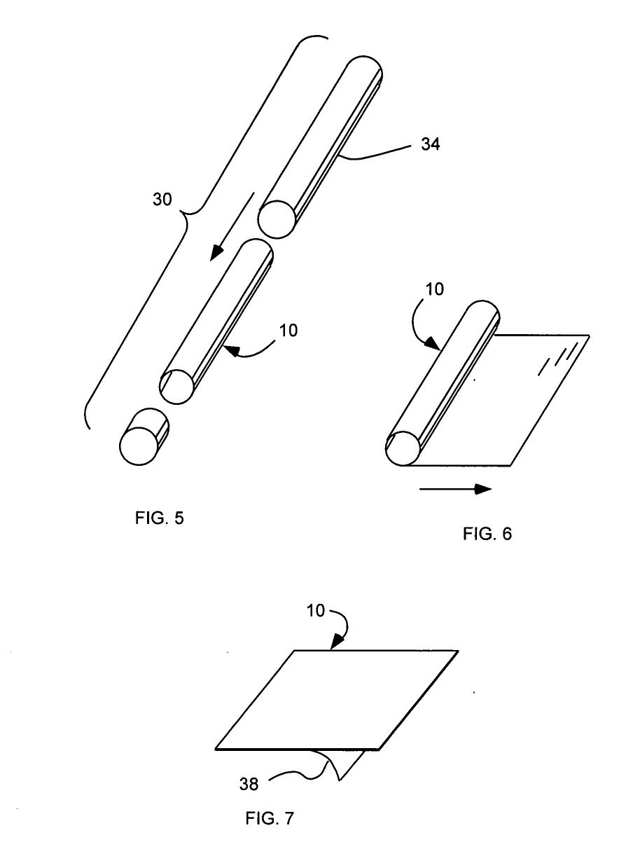

The cover 10 can be provided, packaged, and/or marketed in a package 30 including a tube 34. Thus, the cover 10 can be rolled into a cylindrical configuration inside the tube 34, as shown in FIG. 5. Such a configuration provides the cover 10 with greater rigidity during shipping, and also can resist the formation of creases or folds in the cover or sheet. In addition, the cover 10 can be provided with a backing layer 38 (FIG. 7) to inhibit clinging of the cover to the packaging 30 or tube 34, and to itself when rolled.

A method of using the window cover 10 includes removing the cover 10 from the tube 34, and unrolling the cover 10, as shown in FIG. 6. The backing layer 38 can be peeled away from the cover 10, as shown in FIG. 7. The cover 10 can then be placed against the window 14 so that it clings to the window in a frictional manner. An edge of the cover 10 can be placed against the window, and then subsequent sections can be placed against the window.

It is to be understood that the above-referenced arrangements are only illustrative of the application for the principles of the present invention. Numerous modifications and alternative arrangements can be devised without departing from the scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention.

What is claimed is:

1. A window cover device, comprising:
a) a sheet of material including a polyvinyl chloride material;
b) an opaque section formed across at least a portion of the sheet of material; and
c) an attachment surface of the sheet of material being capable of clinging to a window surface in a frictional manner without mechanical fasteners or chemical adhesives.

2. A device in accordance with claim 1, wherein the sheet of material has a coating of polyurethane forming the attachment surface.

3. A device in accordance with claim 1, further comprising:
a matrix of apertures formed through the sheet of material.

4. A device in accordance with claim 1, further comprising:
a matrix of transparent or translucent sections formed in the opaque section.

5. A device in accordance with claim 1, wherein the sheet of material is opaque; and further comprising a matrix of apertures formed through the sheet and having a uniform diameter, the matrix of apertures extending across an entire surface of the sheet of material, with spacing between adjacent apertures being substantially equal to a diameter of the apertures.

6. A device in accordance with claim 4, wherein the matrix of apertures has a density of apertures of approximately 96 apertures per square inch.

7. A device in accordance with claim 1, wherein the sheet of material has rounded corners.

8. A device in accordance with claim 1, further comprising:
indicia, formed on the attachment surface of the sheet of material, and disposable between the sheet of material and the window surface.

9. A device in accordance with claim 1, further comprising:
indicia, disposed on an opposite surface of the sheet of material opposite the attachment surface.

10. A device in accordance with claim 1, wherein the sheet of material includes:
a) a substantially flat configuration disposable against the window surface; and
b) a rolled-up configuration in which the sheet of material is rolled around itself in a cylindrical configuration.

11. A window cover device, comprising:
a) a sheet of material;
b) a coating of polyurethane formed on the sheet of material defining an attachment surface capable of clinging to a window surface with mechanical or specific adhesion, and without mechanical fasteners or chemical adhesive; and
c) the sheet of material being opaque;
d) a plurality of substantially equally spaced apertures formed through the sheet of material and having substantially uniform diameters.

12. A device in accordance with claim 11, wherein the sheet of material includes a polyvinyl chloride material.

13. A device in accordance with claim 10, wherein the sheet of material includes:
a) a substantially flat configuration disposable against the window surface; and
b) a rolled-up configuration in which the sheet of material is rolled around itself in a cylindrical configuration.

14. A window cover device, comprising:
a) a sheet of polyvinyl chloride material;
b) a coating of polyurethane formed on the sheet of polyvinyl chloride material defining an attachment surface capable of clinging to a window surface with mechanical or specific adhesion, and without mechanical fasteners or chemical adhesive; and
c) the sheet of material being opaque;
d) a plurality of apertures formed through the sheet of material and having substantially uniform diameters and being spaced-apart a substantially uniform distance.

15. A method for providing window covering for shade, comprising the steps of:
a) obtaining a window cover formed of a sheet of material that is rolled into a tubular configuration and disposed within a tubular package;
b) removing the window cover in the tubular configuration from the tubular package;
c) unrolling the sheet of material;
d) removing a backing layer from the sheet of material;
e) applying the sheet of material against a window of a vehicle without mechanical fasteners or chemical adhesive, and with an attachment surface of the sheet of material clinging to the window in a frictional manner;
f) operating the window between i) an open position in which at least a portion of the window, and thus the sheet of material, is received within a door frame of the vehicle, and ii) a closed position;
g) removing the sheet of material from the window; and
h) re-applying the sheet of material to the window or another window without mechanical fasteners or chemical adhesive, and with the attachment surface of the sheet of material clinging to the window in a frictional manner.

16. A method in accordance with claim 15, wherein the sheet of material is formed of a polyurethane material.
